(19) United States
(12) Patent Application Publication
(10) Pub. No.: US 2008/0005131 A1
(43) Pub. Date: Jan. 3, 2008

(54) INFORMATION SECURITY MANAGEMENT SYSTEM

(76) Inventors: Ashley Thomas Naelon, Davidson, NC (US); Kenneth Scott Wiggins, Charlotte, NC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(21) Appl. No.: 11/427,129

(22) Filed: Jun. 28, 2006

(51) Int. Cl. G06F 7/00

(52) U.S. Cl. 707/100

(57) ABSTRACT

An information security management system and tool for developing standards and procedures related to those standards across an organization. The system of the invention takes proposed information technology (IT) requirements for an organization and rationalizes these requirements as standards or procedures or rejects the requirements as neither a standard nor a procedure. Each proposed standard is scored for its relationship to a rule, the risk to the organization from failing to comply with the requirement and the operational impact on the organization. Proposed procedures are also scored for organizational impact. The rationalization score and risk score for the standard to which the procedure relates are also used to score the procedures. Each standard is linked to the rule on which it is based and each procedure is linked to the standard it supports.

### BACKGROUND OF THE INVENTION

This invention relates to information security management and more particularly to a system for managing and developing security standards and procedures that allow the system to quickly adapt to changing security environments.

Many institutions must comply with various rules, policies, regulations, and guidelines, whether established internally, by a regulatory entity, or as a result of legislation (hereinafter “rule” or “rules”). Because some of these rules may place responsibility on the institution for overseeing consistent adherence to the rules, there is an increasing need for a comprehensive process to manage information security across an entire business organization. For very large and geographically diverse organizations, these requirements can create a significant challenge and resource expenditure.

Typically an organization's information security standards and procedures are maintained as static, paper based systems. One problem with such systems is that they require significant management and maintenance, and compliance and audit overhead. These systems also cannot measure the impact of changing regulatory requirements. Nor can they effectively communicate policy through an organization. These systems also do not map regulatory requirements to an organization's policies, standards and procedures. It is also difficult with these systems to identify gaps between the standards and an organization's actual procedures. Finally, these systems are unable to access and group policies for use by a specific target audience.

Thus an information security management system that allows centralized policy management using portal technology is desired.

### SUMMARY OF THE INVENTION

This invention provides an information security management system and tool for developing standards and procedures related to those standards across an organization. The system of the invention takes proposed information technology (IT) requirements for an organization and rationalizes these requirements as standards or procedures or rejects the requirements as neither a standard nor a procedure. Each proposed standard is scored for its relationship to a rule (rationalized), the risk to the organization from failing to comply with the requirement and the operational impact on the organization. These scores are compared to threshold scores to determine if the proposed standard should be adopted as a standard for the organization. Proposed procedures are also scored for organizational impact. The rationalization score and risk score for the standard to which the procedure relates are also used. These scores are compared to threshold scores to determine if the proposed procedure should be adopted as a procedure for the organization. Each standard is linked to the rule on which it is based and each procedure is linked to the standard it supports. The rationalization methodology provides foundation criteria based decision making, which can be used for historical reference, standards justification and support of the standard or process.

In some embodiments the information security management system of the invention includes various modules, applications, or application modules that work together to accomplish information security standards and procedures rationalizations, review and reporting. Information security management modules facilitate the development of standards and procedures by capturing rationalization data and by calculating scores based on the system requirements and data. These can be implemented by a computer system or systems, software, and networks, or by other means. A common database is operatively connected to the information security management module and other modules to maintain the standards, procedures, scores, rules and other data related to the security management function. A reporting function can be provided to facilitate monitoring of the standards and procedures of an organization.

In some embodiments, the invention is implemented via a computing platform or a collection of computing platforms interconnected by a network, such as a corporate intranet, in which case a web browser can facilitate use of the invention. A computer program product or products containing computer programs with various instructions cause the hardware to carry out, at least in part, the methods of the invention. Applications, or modules, such as the previously mentioned information security management module may be operated on a server or workstation. If the applications are running on a server, the modules are accessed from a client workstation. A database is operatively connected to the modules. The database may comprise a plurality of separate data structures or data storage devices that may reside on the same platform as one or more of the application modules, but more typically will reside on a database server. In this computer-based embodiment, the hardware and software together form the means for carrying out the invention.

### BRIEF DESCRIPTION OF THE DRAWINGS

FIG. 1 is a block diagram of some of the computing hardware that is used to implement some embodiments of the invention.

FIG. 2 is a network block diagram of the hardware used to implement the invention in an example embodiment suitable for use in a large enterprise.

FIG. 3 is a flowchart illustrating the overall operation of the information security management system of the invention.

FIG. 4 is a flowchart illustrating the pre-rationalization and filtering module of the system.

FIG. 5 illustrates the pre-rationalization and filtering module and an embodiment of a scripted display or screen shot.

FIG. 6 is a flowchart illustrating the standard rationalization phase of the system of the invention.

FIG. 7 is a flowchart illustrating the standard rationalization module of the system of the invention.

FIG. 8 illustrates the standards rationalization module and an embodiment of a scripted display or screen shot.

FIG. 9 is a flowchart illustrating the standard risk module of the system of the invention.

FIG. 10 illustrates the standards risk module and an embodiment of a scripted display or screen shot.

FIG. 11 is a flowchart illustrating the standard operational impact module of the system of the invention.

FIG. 12 illustrates the standards operational impact module and an embodiment of a scripted display or screen shot.

FIG. 13 is a flowchart illustrating the scoring methodology for the standard rationalization phase of the system of the invention.

FIG. 14 is a flow chart illustrating the procedures rationalization phase of the system of the invention.

FIG. 15 is a flowchart illustrating the procedure operational impact module of the system of the invention.

FIG. 16 illustrates the procedure operational impact module and an embodiment of a scripted display or screen shot.

FIG. 17 is a flow chart illustrating the mapping module of the system of the invention.

FIGS. 18 and 19 are screen shots illustrating the mapping function of one embodiment of the system of the invention.

### DETAILED DESCRIPTION OF EXAMPLE EMBODIMENTS

The present invention can most readily be understood by considering the detailed embodiments presented herein. Some of these embodiments are presented in the context of a large enterprise using a corporate intranet to facilitate the carrying out of the compliance program assessment function; however, these embodiments are examples only. The invention has applicability to any type of information security system in any type of organization.

The term “organization” typically is used to refer to an entity such as a company or association that is making use of the invention. The entity can be large or small. “Standard” as used herein refers to the activities, actions, behaviors, responsibilities, or the like that are required to be enforced by an organization based on the rules applicable to the organization. A standard dictates “what to do” but does not define the detailed steps on how to do it. A standard includes imperative language, such as “must” or “required”, and typically does not use informational, instructional, suggested or guidance language such as “should” or “may”. “Procedure” as used herein refers to detailed security requirements that support the standards. Often procedures refer to specific technology platforms, processes or products and describe a required or preferred way to configure software and/or protect hardware related to a platform or software product. A procedure refers to “how to do” a process in order to achieve a given standard. Procedures constitute the specific steps required to fulfill a standard. A procedure is a detailed, in-depth, step-by-step statement that articulates what is to be done to implement a security standard; essentially how a standard is to be implemented given a specific technology-platform. “Requirement” as used herein refers to proposed standards and/or proposed procedures inclusively and typically comprises a statement of a proposed rule, standard or procedure that has not been rationalized using the system and tool of the invention.

The terms, “module”, “application module”, and “application” are meant to refer to a specific process that is performed as part of the information security system discussed throughout. Often a module corresponds to a software application. Some modules are for processes in which an analyst collects and inputs data to the information security system. The term “work station” as used in this application is intended to encompass any device from which a person accesses the system of the invention.

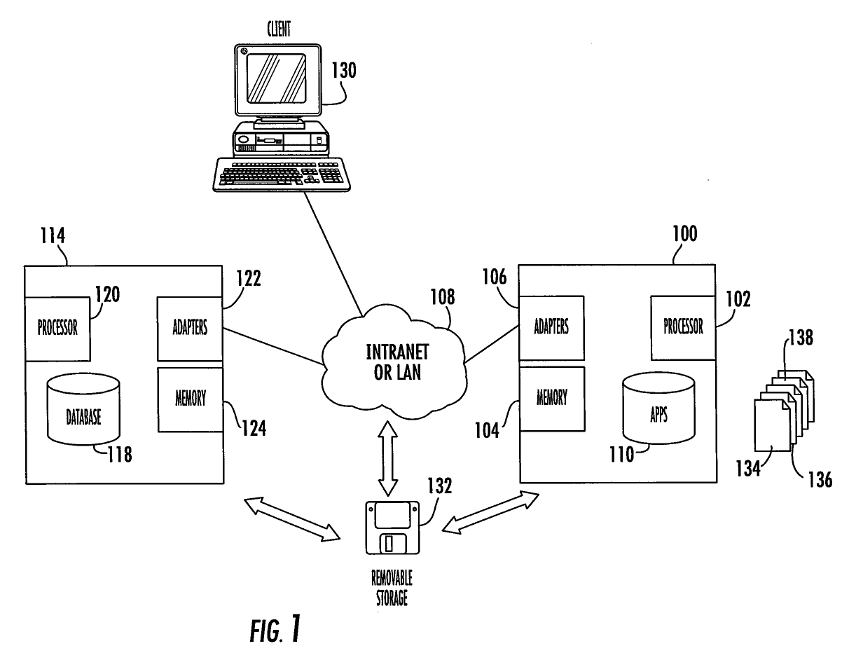

FIG. 1 illustrates, in block diagram form, a view of a computer-implemented embodiment of the invention as it might be implemented on a network. FIG. 1 shows a computing platform 100. The platform is controlled by a processor 102 which serves as the central processing unit (CPU) for the platform. Memory 104 is typically divided into multiple types of memory or memory areas such as read-only memory (ROM), and random access memory (RAM). A plurality of general-purpose adapters 106 are present. At least one, in this example, serves to connect the computing platform to a network 108. The network might be a corporate intranet, or simply a local area network (LAN). Computer program code instructions for implementing the appropriate application modules 134, 136 and 138 are stored on the fixed disk 110. When the system is operating, the instructions are partially loaded into memory and executed by the CPU. Numerous types of general purpose computer systems and workstations are available and can be used to implement computing platform 100. Available systems include those that run operating systems such as Windows™ by Microsoft, various versions of UNIX™, various versions of Linux™, and various versions of Apple's Mac™ OS.

It must be noted that the entire function of the invention, including the common database can be implemented in whole or in part on a single computing platform like that shown in FIG. 1. This might be the case, for example, if a small business were to make use of the invention on a stand-alone personal computer. In other embodiments, however, the common database would be stored on a database server such as an SQL server, as shown at 114 of FIG. 1. In this case, fixed disk storage 118 contains the database. Processor 120, adapters 122, and memory 124 function similarly to those of computing platform 100. If a corporate intranet is used for connectivity, the applications or modules on computing platform 100 can be accessed from a client workstation 130, via a web page.

In any case, a computer program which implements parts of the invention through the use of a system like that illustrated in FIG. 1 can take the form of a computer program product such as MICROSOFT EXCEL spreadsheet residing on a computer usable or computer readable storage medium. Such a medium, a diskette, is shown at 132 in FIG. 1. A computer program product containing the program of instructions can be supplied in such a form, and loaded on the machines involved, either directly, or over a network. The medium may also be a stream of information being retrieved when the computer program product is “downloaded” through the Internet. The computer programs can reside on any medium that can contain, store, communicate, propagate, or transport the program for use by or in connection with an instruction execution system, apparatus, or device. The computer-usable or computer-readable medium may be, for example but not limited to, an electronic, magnetic, optical, electromagnetic, infrared, or semiconductor system, apparatus, device, or propagation medium. Other examples of the computer-readable medium would include an electrical connection having one or more wires, a portable computer diskette or portable fixed disk, an optical fiber, a compact disc read-only memory (CD-ROM), and a digital versatile disc read-only memory (DVD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

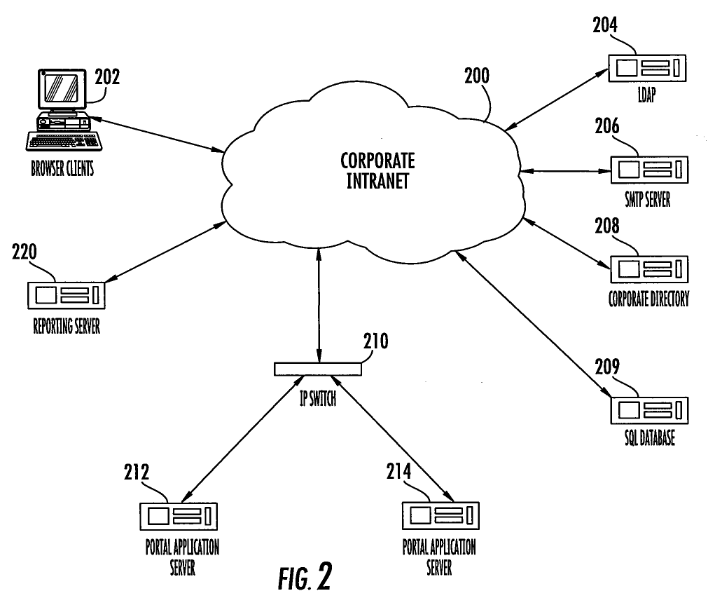

In the embodiment of FIG. 2, the system of the invention takes place via the World Wide Web and is computer-based. This network infrastructure can be used to implement example embodiments of the invention in a large corporate enterprise having a world-wide-web (WWW) enabled corporate intranet, 200. Browser clients 202 access the system via a client computing platform. A lightweight directory access protocol (LDAP) server 204 provides authentication for logging into the system. A commercial software product such as SiteMinder™ from Netegrity, Inc., can be used for this purpose. Simple mail transfer protocol (SMTP) server 206 may be used to generate outgoing notification E-mail messages. A corporate directory server 208 provides access to the organization's master directory of employees and other information necessary when identifying or selecting individuals authorized to access the system of the invention. An internet protocol (IP) switch 210 provides load-balancing to direct sessions to one of two application servers 212 and 214. The switch may be run under the so-called “sticky on=yes” configuration, which assures that once a session is assigned to a portal application server computing platform, the session will continue to work in/from that portal until the session is completed.

In this example embodiment, the application servers run using Microsoft's Internet Information Services (IIS). These servers are the launch point for the system modules and will direct action back and forth among the other servers and databases. The common database which has been previously discussed, is implemented on an SQL server shown at 209. The network of FIG. 2 also includes an IIS-based reporting server, 220, which handles report formats and similar tasks involved with operating the reporting module.

To login, a login request is directed through the IP switch to one of the portal application servers. The application server directs the request to the LDAP server for authentication and the LDAP server authenticates and forwards the request to the SQL database for authentication, confirming that the log-in is to the system. Confirmation and information about the log-in is forwarded back to the application server.

Next, a query may be forwarded to the corporate directory, where information about the log-in is maintained. The type of information may include name, telephone number and possibly postal and Email addresses, manager, line of business or the like. The information is included in a reply and the application server copies it to the SQL database, where the information is stored. This operation is confirmed, and a welcome screen is generated on the work station. From that welcome page, screen shots may be presented to move through the system of the invention. Responses are entered interactively and the database is continually updated. The template resides on the application server and the data in the SQL database.

The system of the invention enables an organization to establish a set of standards and procedures in support of those standards and to link the standards to rules and procedures to the standards. The standards may be developed from rules applicable to the organization. The standards may be grouped by underlying rule; by security topic (e.g. access control, logging or monitoring or the like); by technology path (e.g. Windows Server 2003; or Net Framework or the like); or by user group (e.g. general employee, executive or the like). In order to develop the organization's set of standards and policies a rationalization process is used.

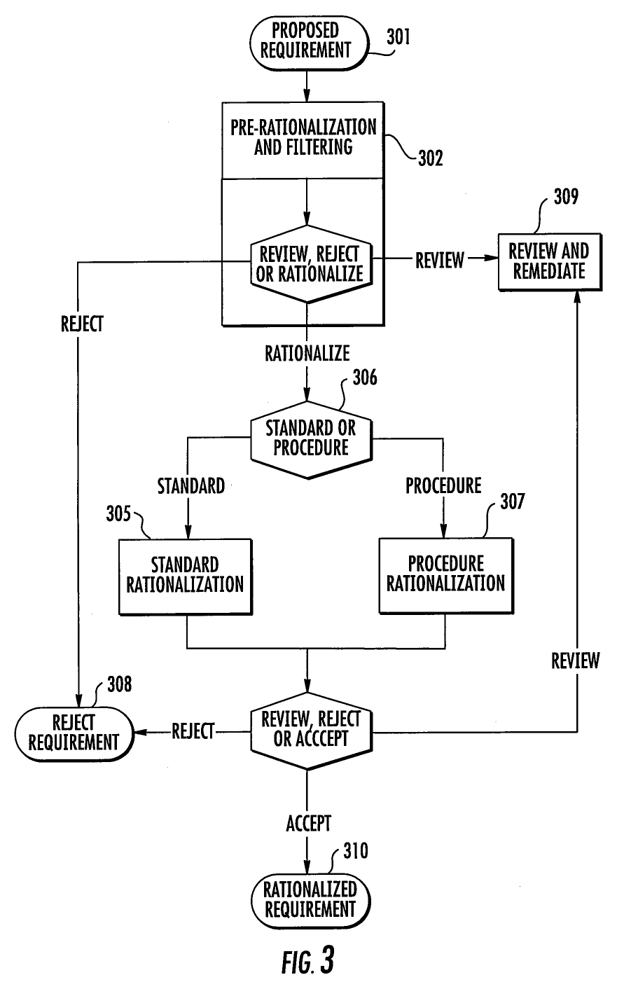

An embodiment of the rationalization process is illustrated in FIG. 3. Initially an organizational requirement is proposed within the organization (block 301). The requirement is typically based on a rule but may be based on any other source. The rationalization process begins with a pre-rationalization and filtering phase (block 302) to determine if the requirement is a standard or a procedure and should be passed to the rationalization phase or if it should be rejected (block 308) or reviewed and remediated (block 309). Requirements that pass the pre-rationalization and filtering stage 302 are passed to either a standard rationalization phase 305 or a procedure rationalization phase 307 where the requirements are rejected 308, reviewed 309, or accepted as a standard or procedure 310.

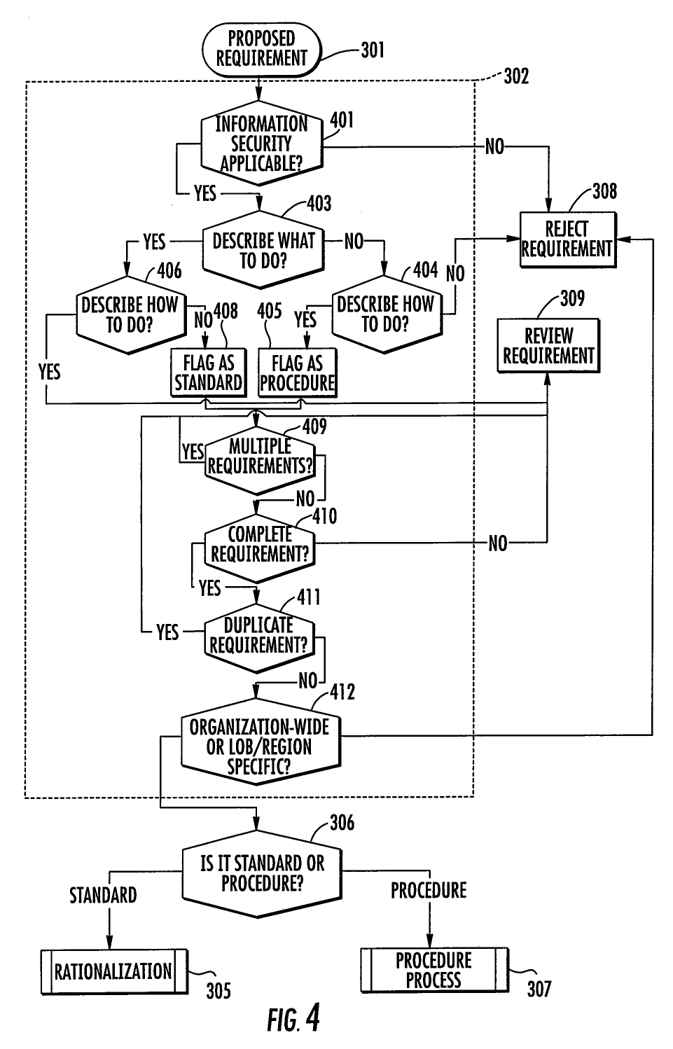

Referring to FIG. 4 the pre-rationalization and filtering module 302 first determines if the proposed requirement applies to information security (block 401). If it is not applicable to information security, then it is rejected (block 308). If it is applicable to information security, then it is determined if the requirement describes “what to do” (block 403). A requirement that describes “what to do” is a potential standard. If it does not describe “what to do” (“NO” in block 403), then the requirement is analyzed to determine if it describes “how to do” (block 404). If it does describe “how to do” (“YES” in block 404), then the requirement is flagged as a potential procedure (block 405). If it does not describe “how to do” (“NO” in block 404), then the requirement is rejected as neither a standard nor a procedure (block 308).

If the requirement describes “what to do” (“YES” in block 403), the requirement is again analyzed to determine if it describes “how to do” (block 406). If it does describe “how to do” (“YES” in block 406), then the requirement is sent for further review (block 309) because the requirement potentially describes both a standard (“what to do”) and a procedure (“how to do”). If it does not describe “how to do” (“NO” in block 406), then the requirement is flagged as a potential standard (block 408).

Standards include imperative language, such as “must” or “required”, and typically do not use informational, instructional, suggestive and guidance language such as “should” or “may”. Requirements that include non-imperative language are flagged for review (block 309), and during this review, the requirements are analyzed to determine if the requirement it is necessary or just a suggestion. If it is deemed necessary, then the requirement must be rewritten to remove any non-imperative language (e.g. change “should” to “must”) and the pre-rationalization process is recommenced for the rewritten requirement. Requirements that are not deemed to be necessary may be considered as possible best practices, to be handled in a different process.

The following pre-rationalization and filtering methodology is followed for both proposed procedures and proposed standards. The proposed standard/procedure is analyzed to determine if it contains only one unique standard/procedure or multiple standards/procedures (block 409). If it contains multiple standards/procedures, then the requirement is flagged for further review (block 309). During the review process, the requirement is separated into multiple singular requirements that fit the criteria for a standard or a procedure. The pre-rationalization process is recommenced for each requirement.

The proposed standard/procedure is also analyzed to determine if the language is complete and can be clearly understood (block 410). Incomplete or vague requirements are flagged for further review (block 309), and are reworded based on the appropriate underlying rule. Once modified, the pre-rationalization process is recommenced for that requirement.

The proposed standard/procedure is then analyzed to determine if it is a duplicate of a standard or procedure that has already been rationalized (block 411). In order to make this determination, a repository of all standards and procedures that have passed through the pre-rationalization and filtering phase is maintained in memory 104 or data base 118 and a keyword search is performed to ensure that the intent of the proposed standard/procedure has not already been captured by another standard or procedure. If a second comparable standard/procedure is located, both potential standards/procedures are reviewed (block 309) to determine which standard/procedure better describes the intended objective. The better standard/procedure is maintained and the less descriptive one is removed.

The standard/procedure is then analyzed to determine if it is applicable to the entire organization or if the standard only applies to subset business lines and/or geographical location (block 412). Any standard/procedure that applies only to a subset of business lines and/or geographical areas may be rejected (block 308). Once these steps have been completed, the requirement can be processed for standard rationalization (block 305) if it was flagged as a standard (block 306) or processed for procedure rationalization (block 307) if it is flagged as a procedure (block 306).

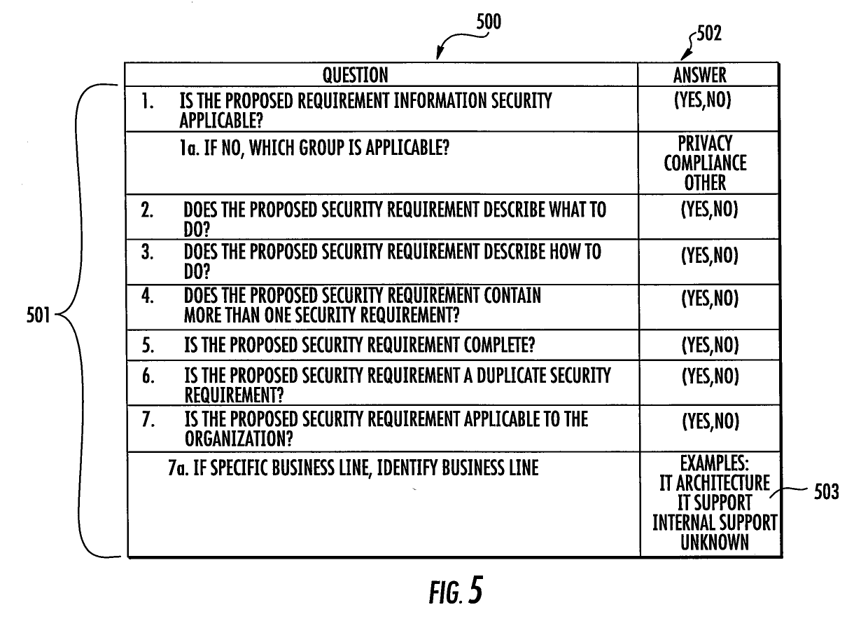

The pre-rationalization and filtering process described above can be operated as a scripted menu driven computer based operation. An example script is set forth in FIG. 5. Script 500 may be displayed on a work station that presents a series of questions 501 where the answers 502 to those questions are entered into the system and saved in memory 104 or data base 118 to create and maintain a repository of all standards and procedures for the organization. Each question 501 is provided with a “YES” or “NO” answer choice that may be selected by clicking on an appropriate icon on the display. For requirements that are applicable to less than the entire organization, a field 503 may be provided in which the specific business line is identified.

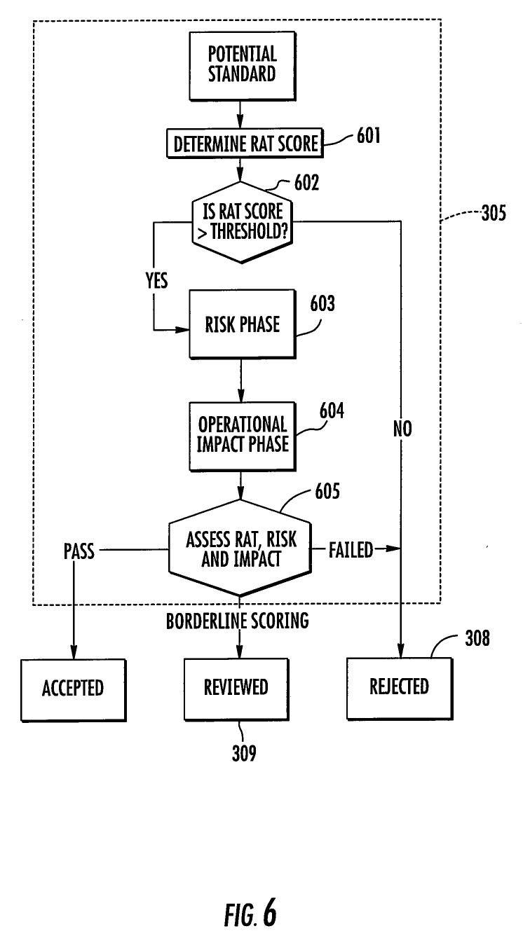

Security requirements that are identified as potential standards using the pre-rationalization and filtering process described with respect to FIG. 4 are then put through a standard rationalization module 305, the details of which are illustrated in FIG. 6. The rationalization module relates a standard to the reason it is being proposed as a standard (i.e. the rule) and assesses the importance of implementing the proposed standard or conversely the risk associated with not meeting the standard. The system first determines a rationalization (RAT) score for the proposed standard (block 601). The rationalization score determines the rule(s) to which the standard applies and the relative importance of that rule(s).

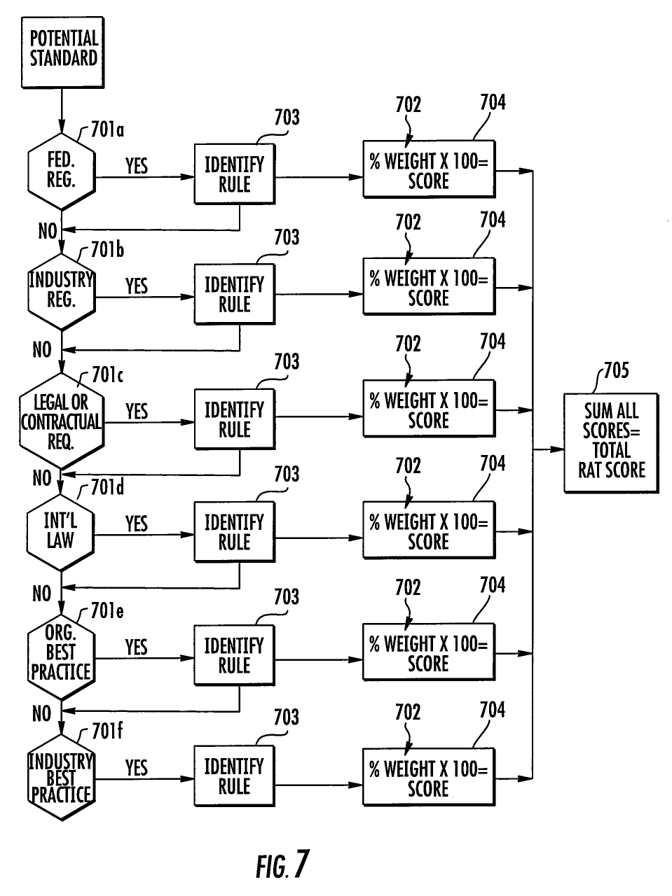

Referring to FIG. 7, in order to determine the RAT score of block 601, a RAT score module 700 is used. The system first identifies the potential sources of a standard (the rules). These rules may be any rule applicable to the organization. Example sources include federal regulations, industry specific regulations, legal or contractual requirements, international law, organization best practice, management directive and industry best practice. Other sources may also apply depending on the specific industry, location of the organization and the forgoing list is made by way of example only. FIG. 7 shows examples of rules (blocks 701a through 701f). The rules shown in FIG. 7 are by way of example only and other and different sources may be identified by an organization.

Once the potential sources of a rule are identified, a weight 702 is assigned to each rule source 701a through 701f. In one embodiment each rule is given a percentage weight out of one-hundred percent for all the rules. In other words the sum of the percentage weights of all rules must equal 100%. In the illustrated embodiment rules 701a through 701d deal with regulations or legal requirements and are deemed to be more important than rules 701e and 701f which are organizational best practices. Thus, the first four rules 701a through 701d may be weighted more heavily than the other two rules. The weights 702 may vary depending upon the importance of each source. The list of possible sources and the weights are saved in memory 104 or data base 118.

For any proposed security standard, the specific rule from which the proposed standard is derived is identified (blocks 703). The system stores a record of the responses for each standard that is rationalized and a record for that standard is maintained in memory 104 or data base 118. For any source identified as supporting the standard, the weight percentage is multiplied by 100 to give a subtotal score (blocks 704). The subtotal scores for each question are summed to get a total rationalization score (RAT score) (block 705).

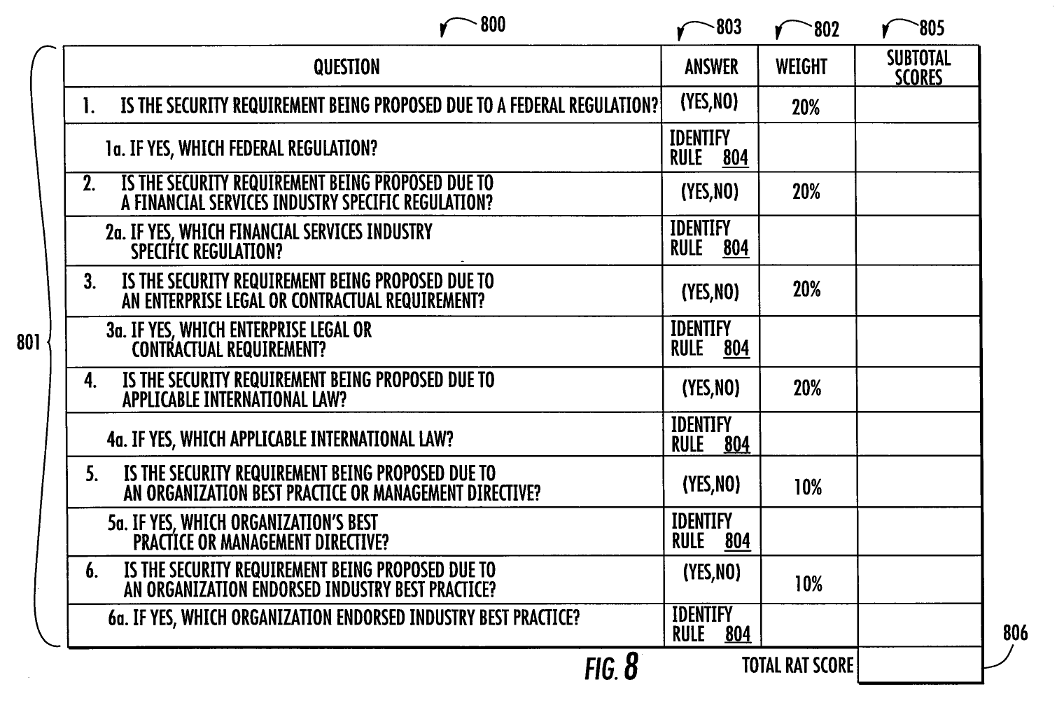

The rationalization process described above can be operated as a scripted menu driven computer based module an embodiment of which is shown in FIG. 8. The script may be displayed on a work station that is presented as a series of questions 801 where the answers 803 to those questions are entered into the system and saved in memory 104 or data base 118 that is a repository of all standards and procedures for the organization. Each question is provided with a “YES” or “NO” answer choice that may be selected by clicking on the appropriate icon on the display. The weights 802 are displayed and the system generates the subtotal score in fields 805 for that rule as previously described. A field 804 is provided for receiving an identification of the specific rule as input such as by using a keyboard at a work station. The module calculates the total RAT score as previously described and displays this score in field 806.

Referring again to FIG. 6, the total RAT score as determined by module 700 is compared to a RAT threshold score (block 602). If the total RAT score is above the RAT threshold score, the requirement is moved to the risk phase (block 603) as will hereinafter be described. If the RAT score is below the RAT threshold score, the requirement is rejected (block 308). The RAT threshold score is determined based on the importance of the sources underlying the requirement. Some sources may be of such a nature that the organization may safely ignore a requirement from that source. Moreover, The RAT threshold may also be zero where compliance with standards derived from all sources is determined by the organization to be critical.

Referring again to FIG. 6, after performing the rationalization process, a standard risk module is launched where the risk associated with each qualifying standard is analyzed (block 603). Risk is the likelihood or probability that a loss of information resources or breach of security will occur if the standard is not complied with. The higher the risk, the greater the incentive is to implement the standard. The consequence of an information security risk is best defined through business impacts. When assessing risk, the analyst must understand and evaluate the business impact if the proposed security requirement is not adopted.

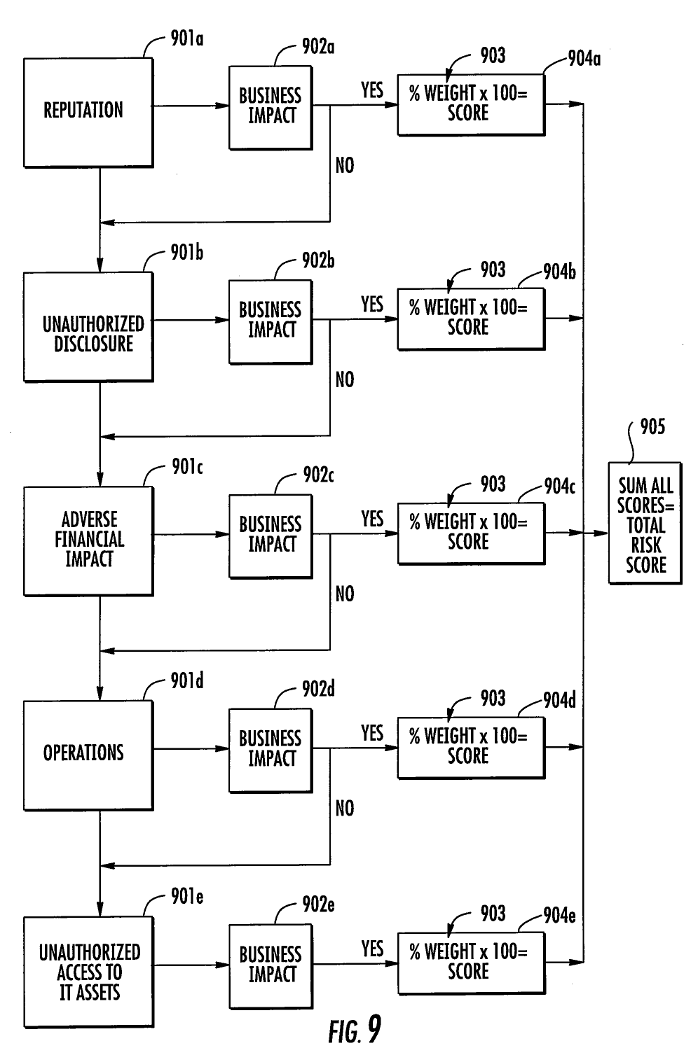

Referring to FIG. 9, in order to determine risk, the standard risk module 900 is used by first identifying the potential risks (blocks 901a through 901e) of not complying with a standard. These potential risks may be any risk applicable to the organization. Example risks include damage to the organizations reputation or brand; unauthorized disclosure of consumer, organization or associated business information; financial harm; risk to operations; and unauthorized access to the organization's Information technology assets. Other risks may also apply depending on the specific industry, location of the organization and the forgoing list is made by way of example only.

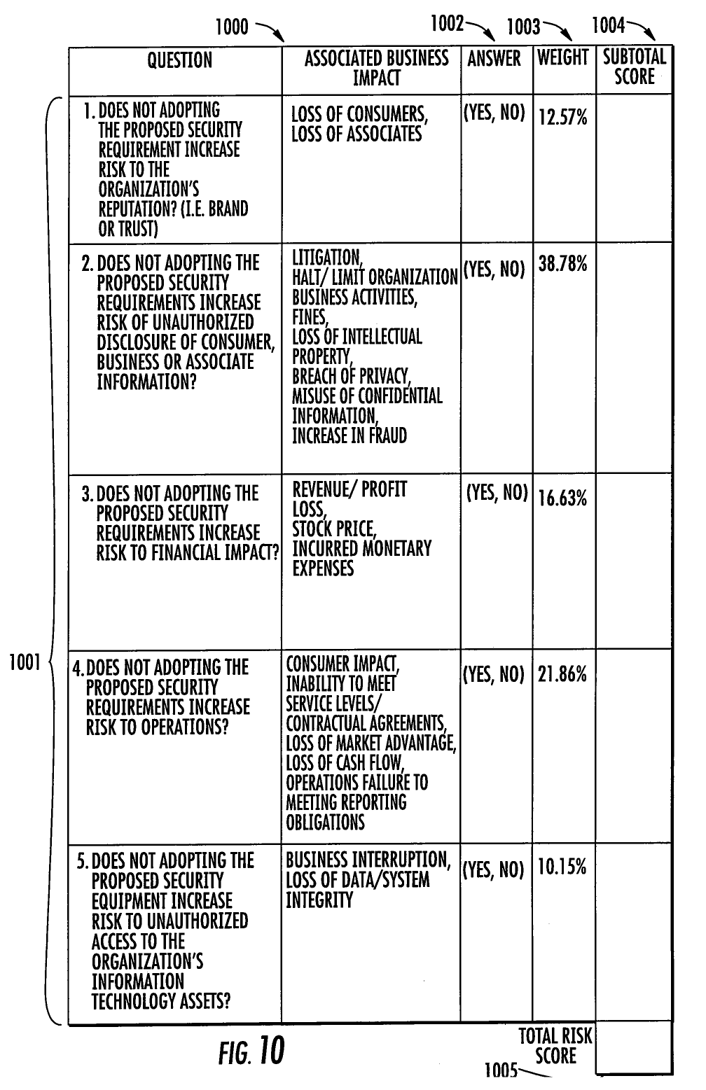

Once the potential risks of failing to comply with the rules are identified, the associated business impacts (blocks 902a through 902e) are identified for each risk (examples are given in FIG. 10). These business impacts set forth the real world affects of a failure to comply with a rule. These business impacts are not exhaustive and other business impacts may be identified for the listed risks or for other risks.

A weight 903 is assigned to each risk. In one embodiment each risk is given a percentage weight out of one-hundred percent for all the risks. In other words the sum of the percentage weights of all risks must equal 100%. The weightings may vary depending upon the importance of each business impact for the organization.

For each proposed security standard, it is determined if any of the risks may result because of a failure to comply with that proposed standard. For any identified risk, the weight percentage is multiplied by 100 to give a score (block 904a through 904e). The scores for each question are summed to get a total risk score (block 905). The total risk score provides an indication of the risk to the organization for failure to comply with the requirement.

The risk process described above can be operated as a scripted menu driven computer based operation. The risk module presents a script 1000, an embodiment of which is illustrated in FIG. 10, on a display at a work station that presents a series of questions 1001 to an analyst where the answers 1002 to those questions are entered into the system and saved in memory 104 or data base 118 to create a repository of all risks for each standard and procedure for the organization. Each question is provided with a “YES” or “NO” answer choice that may be selected by clicking on the appropriate icon on the display. The weights are displayed in field 1003 and the system generates the subtotal scores as previously described that are displayed in field 1004. The total risk score is calculated as previously described and is displayed in field 1005.

Referring again to FIG. 6, after performing the risk analysis 603, the operational impact 604 associated with each proposed standard is analyzed. Operational impact is the difficulty, risk or problems associated with implementing a proposed standard. The higher the operational impact, the greater the problem for the organization to implement the standard.

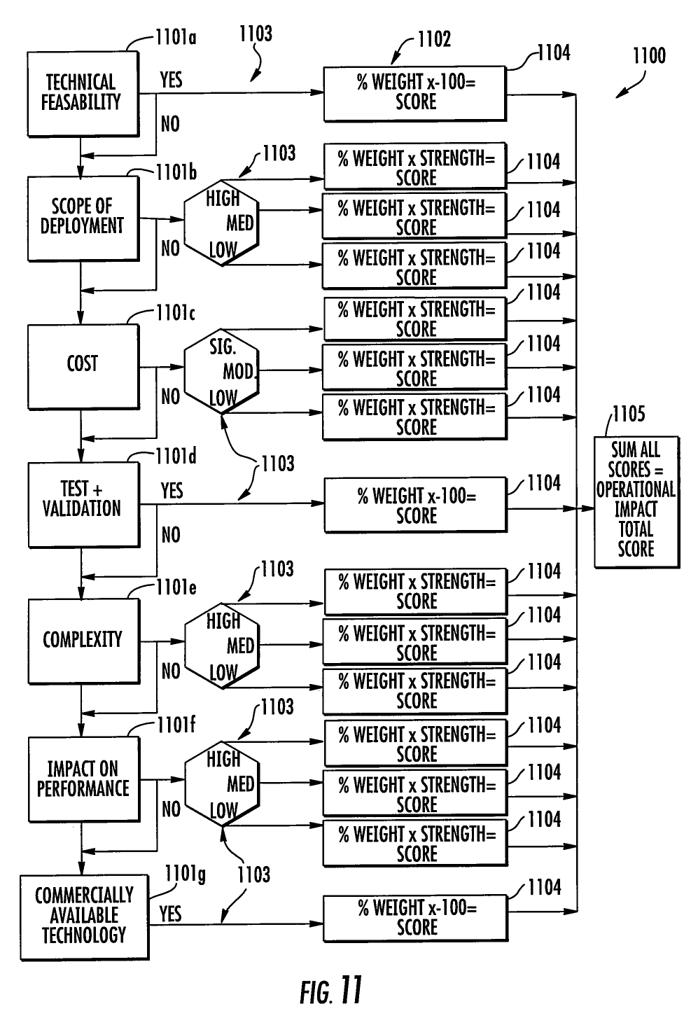

Referring to FIG. 11, in order to determine operational impact, the standard operational impact module 1100 is set up by first identifying the operational impacts (blocks 1101a through 1101g) required to comply with a standard. These impacts 1101a-g may be any impact on the organization in ensuring compliance with the standard. Example operation impacts include is implementation technically feasible; the scope/magnitude of deployment; cost; ability to test and validate prior to implementation; impact on performance; and is the technology available to the organization. Other operational impacts may also apply depending on the specific industry, location of the organization and the forgoing list is made by way of example only.

Once the operational impacts 1101 are identified, a weight 1102 is assigned to each operational impact 1101a through 1101g. In one embodiment each operational impact is given a percentage weight out of one-hundred percent for all the sources. In other words the sum of the percentage weights of all sources must equal 100%. The weightings may vary depending upon the importance of operational impact.

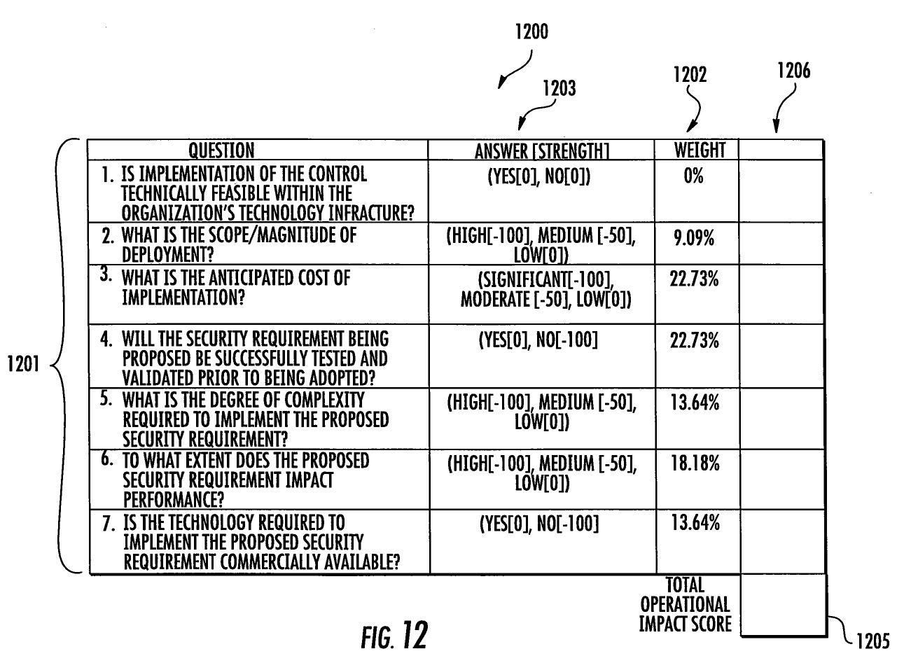

Unlike the rationalization and risk assessment analyses, operational impacts 1101 may be rated on a three tiered (e.g. high, medium, low) system rather than a two tired (e.g. yes/no) system. The possible “Answers” 1103 contains both the answer and the strength of value if selected. Examples of the weight and strength of value (shown in brackets) are shown in FIG. 12 in fields 1202 and 1203, respectively. For operational impact No. 2 the weight of the impact is 9.09% and the strength of the answers is high −100; medium −50 and low 0. For two tiered answers the strength of the answers is yes 0 and no −100 such that for a no answer the weight is multiplied by −100 and a yes answer is zero. To obtain the score for each operational impact the weight is multiplied by the answer's strength (blocks 1104). For example if an analyst answered the second question “medium”, then the operational impact score would be (−50)×(9.09%)=−4.545. Summing all of the question scores gives the total impact score, which is used for the final assessment (block 1105).

The rationalization process described above can be operated as a scripted menu driven computer based operation. A script 1200 is presented on a display at a work station, one embodiment of which is shown in FIG. 12, as a series of questions 1201 where the answers 1203 to those questions are entered into the system and saved in memory 104 or data base 118 to create a repository of all standards and procedures for the organization. Each question is provided with a two-tiered “YES” or “NO” answer choice or a three-tiered “HIGH”, “MED” or “LOW” answer choice that may be selected by clicking on the appropriate icon on the display. The weights are displayed in field 1204 and the system generates the subtotal score for each impact as previously described and displays the scores in field 1206. The module calculates a total operational score as previously described and displays this score in field 1205.

Referring again to FIG. 6, the RAT, risk and impact scores are used to determine if a proposed standard should be established as a standard for the organization (block 605). Any standard that does not pass the rationalization stage (block 602) is immediately rejected (block 308) and does not have to be scored and risk or impact.

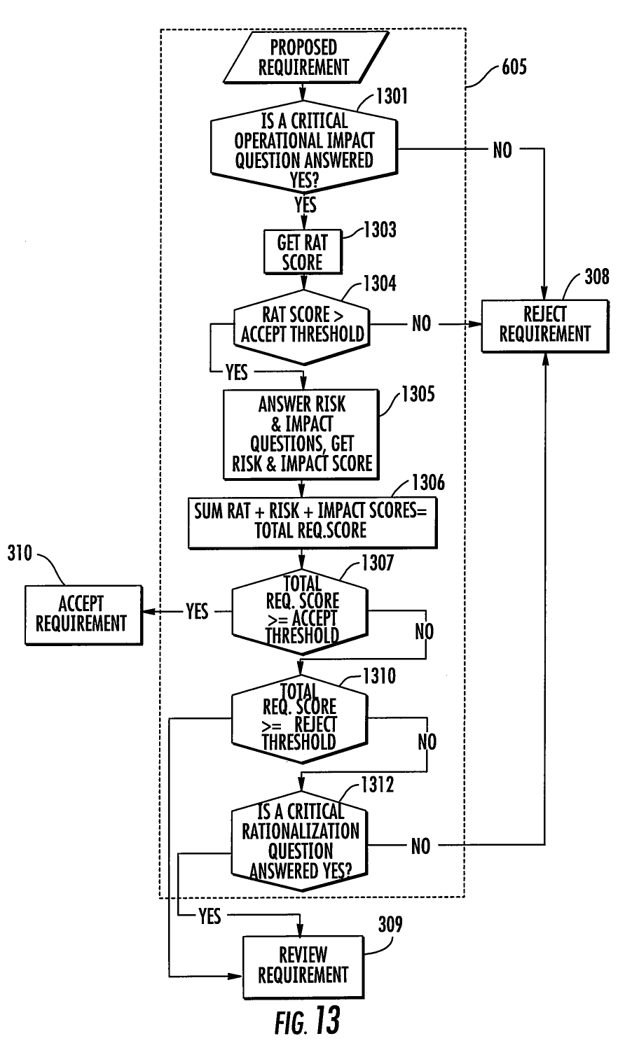

The logical flow of scoring (block 605) is shown in FIG. 13. Scoring for the risk and impact section is calculated based on the answers to the questions in the risk and impact application modules. The total risk scoring can range from 0 to 100, while the total impact scoring can range from 0 to −100. Therefore, the sum of the risk and impact scores is between −100 and 100. This scoring framework is used in order to achieve a balance between risk and impacts. A negative risk and impact total implies that the proposed security requirement may not be worth implementing because of its high impact and low risk. On the other hand, a positive risk and impact total implies that a security standard should be implement because it has a high risk and low impact.

For each proposed standard, a determination may first be made if a critical operational impact is affected (block 1301). A critical operational impact is an impact that may prevent compliance with the standard regardless of the scoring. If such a critical operational impact is identified, the standard is rejected (block 308). If no critical operational impact is identified, the RAT score is determined as previously described with respect to FIGS. 7 and 8 (block 1303). If the RAT score is below the threshold (block 1304), the requirement is rejected (block 308). If the RAT score is above the threshold (block 1304), the risk and impact analyses are conducted as previously described with respect to FIGS. 9-12 (block 1305).

The rationalization, risk and impact scores are summed to obtain a total requirement score (block 1306). If the total requirement score is greater than the accept threshold (block 1307), then the proposed requirement is accepted as a standard (block 310). If the total requirement score is above the “reject” threshold, but below the accept threshold (borderline scoring) (block 1310), then proposed requirement is reviewed (block 309). Standards that are reviewed must be reprocessed through risk and impact modules. If the sum is less than the reject threshold, a determination is made if a critical rationalization question was answered “yes” (block 1312). A critical realization question is one where the failure of compliance may result in substantial harm to the organization. The use of critical risk, rationalization or impact questions enables the system to accommodate standards or procedures that may otherwise be rejected by the scoring calculations where those standards or procedures are deemed essential or critical to the organization. If one of the critical risks is answered affirmatively, then the proposed standard is reviewed (block 309). If none of the critical risks is answered affirmatively, then the proposed standard is rejected (block 308).

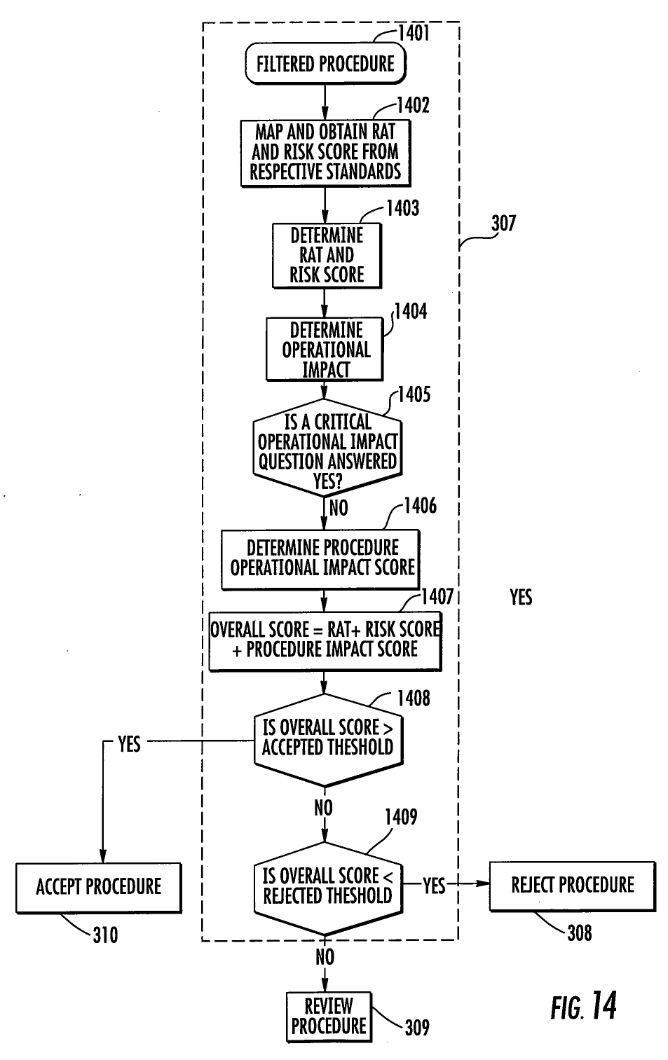

The rationalization process for procedures (block 307) will now be described with respect to FIG. 14. Security requirements that have been identified as procedures and have passed the pre-rationalization and filtering process (block 1401) are then passed through the procedure rationalization process. Procedures can be accepted, rejected, or tagged for review.

A procedure is a detailed, in-depth, step-by-step statement that articulates what is to be done to implement a security standard; essentially how a standard is to be implemented given a specific technology-platform. For this reason, the rationalization and risk process used for standards, described above, are not applied to procedures. Rationalizing procedures is focused on the operational impact on the organization that the procedure introduces.

Given that procedures are technical implementations of standards, every procedure has a respective rationalization and risk associated with it due to the standard it implements. Since a standard is associated with a particular rule, then the procedure that implements that standard is associated with the same rule. Therefore, the rationalization and risk introduced by a standard applies to the procedure that is created to comply with the standard. As a result of this relationship, the rationalization and risk scores for a procedure are obtained from the rationalization and risk scores of the standard(s) to which it maps. To be able to leverage rationalization and risk scores computed for standards in assessing procedures, each procedure must be mapped to the standard or standards is supports (block 1402).

The RAT and risk score for the standard(s) is used as the RAT and risk score for the procedure mapped to that standard(s) (block 1403). If a procedure is mapped to a single standard, the RAT and risk score for that standard is used. However, if a procedure is mapped to more than one standard then several RAT and risk scores will apply to the procedure and an overall RAT and risk score must be computed. There are several methods that can be used to calculate these scores. In one embodiment, an advanced mean calculation is used based on the lowest score, the highest score, and the most likely score values. Given a sorted list of RAT and risk scores (in increasing order) the following calculation will provide a fairly accurate representation of the RAT and risk score that applies to the procedure:

### R&R—RAT and Risk scores

### Lowest R&R—R&R_{L}

### Highest R&R—R&R_{H}

### Median R&R—R&R_{M}

### Mean R&R=⅙(R&R_{L}+(4×R&R_{M})+R&R_{H})

The median R&R is calculated as follows:
1. Sort the scores in an increasing order.
2. If there is an odd number of scores, the median is the center score.
3. If there is an even number of scores, add the two middle scores and divide by two.

### Calculation Example:

A procedure is mapped to 4 standards with the following RAT and risk scores: 120, 40, 30, and 180
The scores in increasing order are 30, 40, 120, and 180
The R&R_{M}=(40+120)/2=80
The Mean R&R=⅙*(30+4*80+180)=88.33

Therefore the RAT and risk score that should be used for the procedure to calculate its overall score is 88.33.

In another embodiment, the highest RAT and risk score (i.e. the worst case scenario) is calculated.

The operational impacts for the procedure is then determined (block 1404). The operational impacts associated with procedures differs from the operational impacts associated with standards. Operational impact is the difficulty, risk or problems associated with implementing a certain procedure. Procedures are more objective than standards and therefore the operational impact questions may be more detailed. The operational impacts and associated score for procedures are determined independently of the operational impact score for the related standard(s). After the operational impacts are determined (block 1404) critical operational impacts are reviewed (block 1405). If a critical operational impact is identified (block 1405), the procedure is rejected (block 308). The critical impact analysis may be used where an organization determines that one of the operational impacts prohibits the implementation of a procedure.

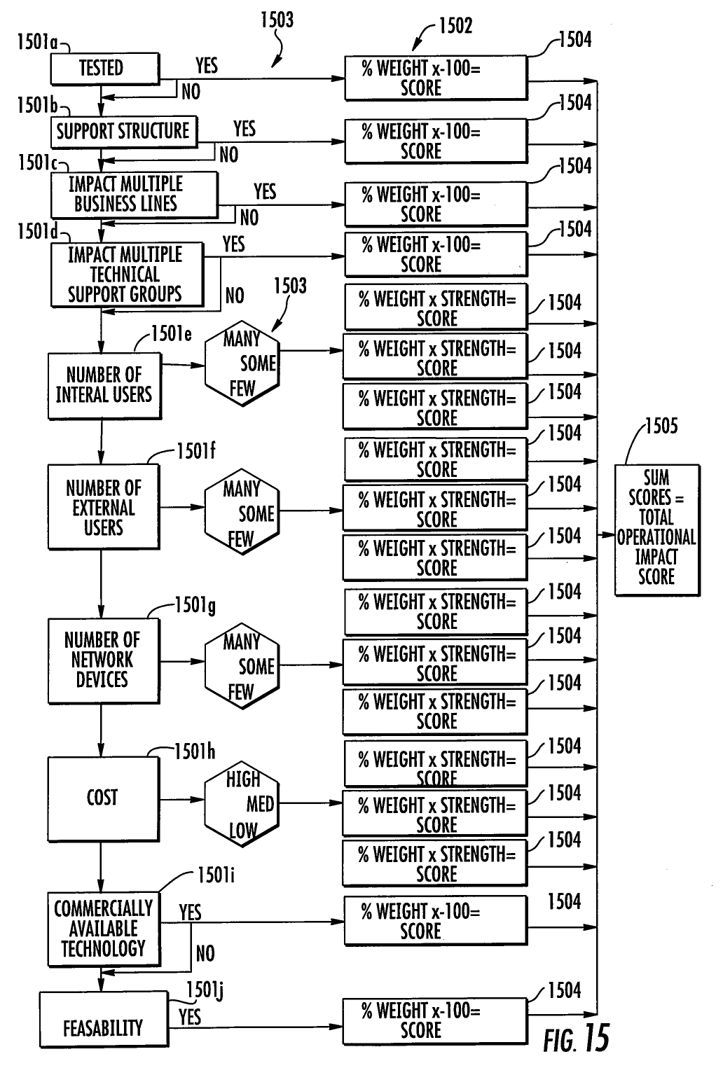

The operational impact score for the procedure is then determined (block 1406). Referring to FIG. 15, in order to determine operational impact, the procedure operational impact module is set up by first identifying the operational impacts (blocks 1501a though 1501j) required to comply with the procedure. These operational impacts may be any impact on the organization that results from instituting or following the procedure. Example operation impacts include implementation technical feasibility; the scope/magnitude of deployment; cost; ability to test and validate prior to implementation; impact on performance; and availability of the technology. Other operational impacts may also apply depending on the specific industry, location of the organization and the forgoing list is made by way of example only.

Once the operational impacts 1501a through 1501j are identified, a weight 1502 is assigned to each operational impact. In one embodiment each operational impact is given a percentage weight out of one-hundred percent for all the operational impacts. In other words the sum of the percentage weights of all sources must equal 100%. The weights may vary depending upon the importance of operational impact.

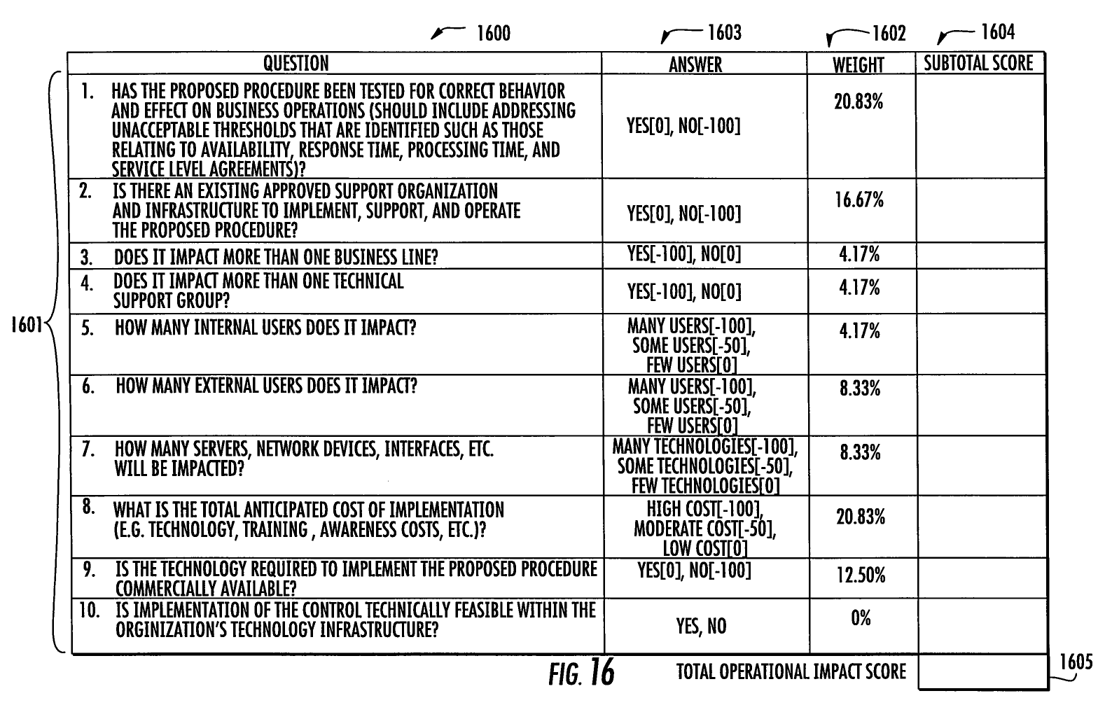

These operational impacts 1501a through 1501j may be rated on a two tiered system (yes/no) or a three tiered (i.e. high, medium, low) system. The possible “Answers” 1503 contains both the answer and the strength of value if selected. The weight is multiplied by the answers strength (blocks 1504). Examples of the weight and strength of value (shown in brackets) are shown in FIG. 16 in fields 1602 and 1603, respectively. For operational impact number 5 the weight of the impact is 4.17% and the strength of the answers is high −100; medium −50 and low 0. To obtain the score for each operational impact the weight is multiplied by the answer's strength (block 1504). For example if an analyst answered question 5 “medium”, then the operational impact score would be (−50)×(4.17%)=−2.085. Summing all of the question scores gives the total impact score for the procedure, which is used for the final assessment (block 1505).

The rationalization process described above can be operated as a scripted menu driven computer based operation. A script 1600 is presented on a display at a work station, one embodiment of which is shown in FIG. 16, as a series of questions 1601 where the answers 1603 to those questions are entered into the system and saved in memory 104 or data base 118 to create a repository of all standards and procedures for the organization. Each question is provided with a two-tiered “YES” or “NO” answer choice or a three-tiered “HIGH”, “MED” or “LOW” answer choice that may be selected by clicking on the appropriate icon on the display. The weights are displayed in field 1602 and the system generates the subtotal score for each impact as previously described and displays the scores in field 1604. The module calculates a total operational score for the procedure as previously described and displays this score in field 1605.

Referring again to FIG. 14, the RAT+risk score previously determined is summed with the operational impact score to obtain an overall score (block 1407). If the overall score is greater than an accept threshold (block 1408), then the procedure will be accepted (block 310). If the overall score is less than the accept threshold (“No” in block 1408), then a determination is made whether the Overall score is less than the reject threshold (block 1409). If the overall score is less than the reject threshold (“Yes” in block 1409), the procedure is rejected (block 308). If the score is in between the two thresholds (“No” in block 1409), the procedure must be reviewed (block 309).

Standards and procedures that have been targeted for review must be remediated by either modifying or rejecting the requirement. The remediation steps are determined based on the reason the requirement was sent for review. Every requirement marked for review should have a corresponding reason. The table below outlines the steps necessary for potential reasons.

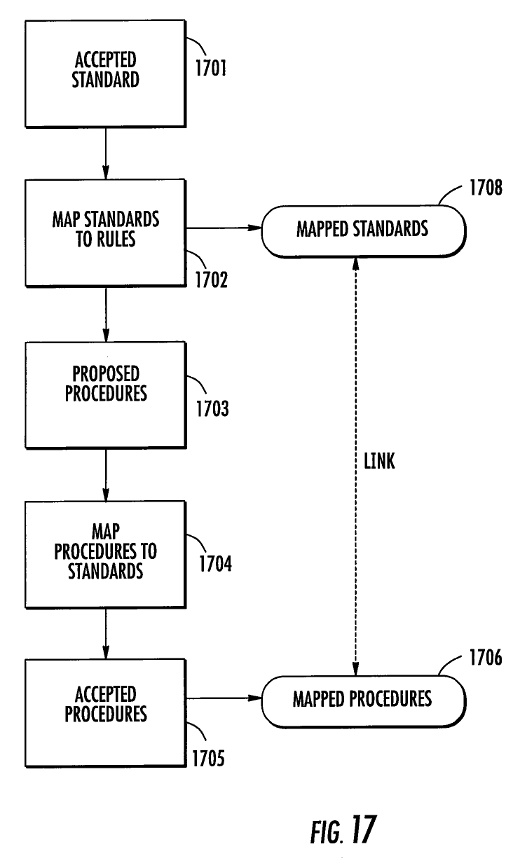

In the completely rationalized system, the standards and procedures are rationalized and reviewed and remediated, if needed, the procedures are mapped to the standards, and the standards are mapped to the rules. Referring to FIG. 17, the accepted standards (block 1701) are first mapped to the underlying rule (block 1702) before the procedures are linked to the standards to obtain a repository of mapped standards (block 1708). One advantage of mapping standards to the rules is to be able to link each standard to the regulations and best practices which improve compliance. Ideally, there is a one to one match between a standard and a rule, however there may be cases when a standard either does not map to any rule, or a standard maps to more than one rule. These cases should be reviewed.

One method to link a standard to a rule is to identify key words from the statement of the standard. The key words are used as search terms of the underlying rule. The rules identified from the search are reviewed and if the security requirement of the standard has the same objective as the rule, the standard is linked to the rule.

The proposed procedures are then linked or mapped to the standards (block 1704). This mapping is the mapping discussed with respect to FIG. 14 as part of the procedure rationalization phase (block 1402). Ideally there should be a one to one mapping between a procedure and a standard; however, there may be cases where implementation of a procedure can realize more than one standard. These cases should be documented. The method for linking the procedures to the standards is similar to the method for linking standards to rules. Key words from the statement of the procedure are identified. The key words are used as search terms of the standards. The standards identified from the search are reviewed and if the procedure statement is the implementation of the standard statement, the procedure is linked to the standard. The procedure is accepted as previously described (block 1705) such that each accepted procedure is mapped to the standard(s) it supports and the mapping is retained in a repository of mapped procedures (block 1706).

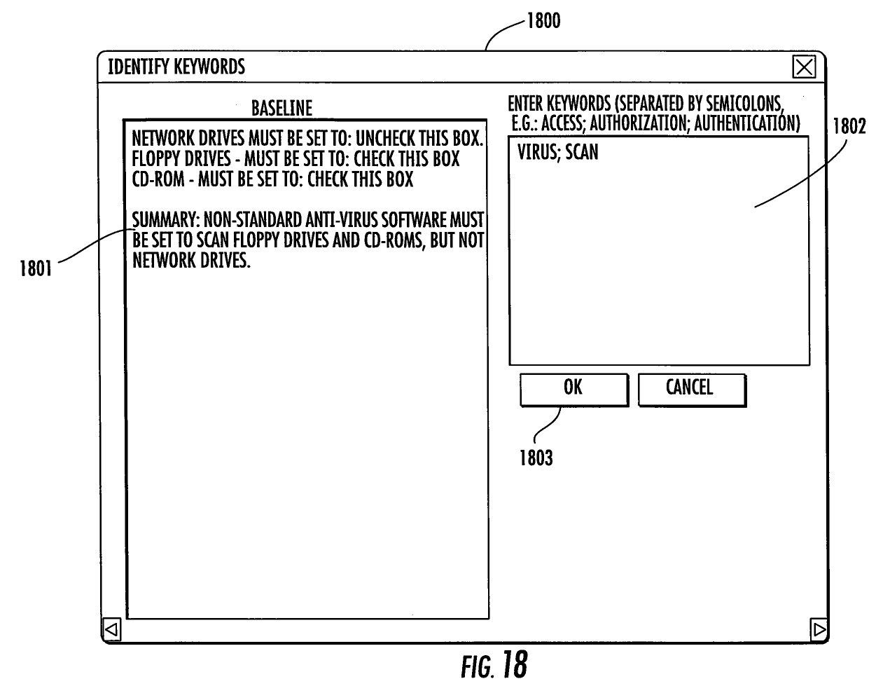

The tool has the ability to map procedures to standards. If no problems were found during the filtering stage and the security requirement is a procedure, a mapping module will be executed. The first screen 1800 developed by the mapping module is shown in FIG. 18 shows the procedure statement on the left panel 1801. The right panel 1802 is used to input keywords that relate to the procedure. Once the key words are input, a search button 1803 is selected and the linking module searches all standards in the system repository for the keywords.

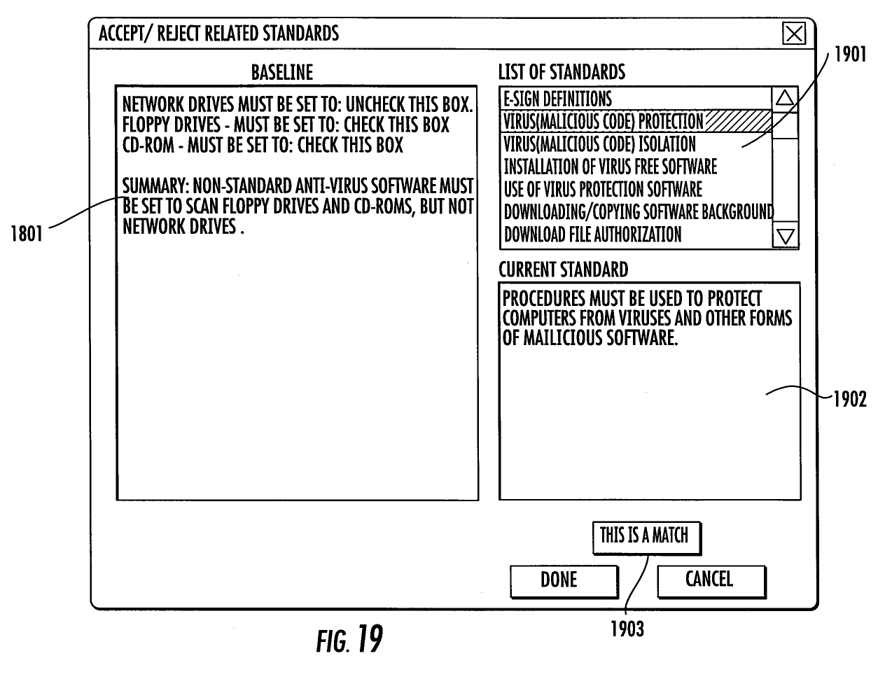

Referring to FIG. 19, the mapping module allows a search of the keywords within the “Standards” and identifies any standards that contain the keywords in panel 1901. The procedure statement will be displayed in the left panel 1801. In panel 1902 the standard statement corresponding to the standard that is highlighted in panel 1901 is displayed. A side-by-side comparison of the procedure and standard statement can be made to easily identify if the procedure and standard are related. If the procedure statement is in fact an implementation of the current standard statement, then the user can press an enter button 1903 to automatically map or link the standard with the procedure. The user will press “Done” when the mapping is completed. Once the mapping is complete, every procedure will be linked to its related standard and each standard will be linked to its related rule.

Once the responses are captured in data base 118 the data can be retrieved by the organization to review and update the data or to monitor the information security standardization of the organization. The data stored can also be reported in a variety of formats. This reporting, for example, can be used to show the standards and procedures of an organization or any subset of information. Standard reports may be automatically developed and presented by a reporting module. A copy of the reports may be distributed to appropriate levels of the organization to monitor and manage the standardization activities of the organization. The standardization process and data base may be updated periodically such as quarterly to ensure that the organization is current in its standards compliance activities. Because the underlying rules, the applicable standards, the related processes and the scores are maintained in the data base a historical record is maintained for organization. Thus, the rationalization methodology provides foundation criteria based decision making, which can be used for historical reference, standards justification and support of the standard or process.

Specific embodiments of an invention are described herein. One of ordinary skill in the computing and networking arts will quickly recognize that the invention has other applications in other environments. In fact, many embodiments and implementations are possible. The following claims are in no way intended to limit the scope of the invention to the specific embodiments described above.

1. A standard and procedure rationalization system comprising:
a proposed standard;
a module for scoring the proposed standard;
a proposed procedure;
a module for scoring the proposed procedure;
a module linking the proposed standard to a rule and linking the proposed procedure to the proposed standard; and
a database operatively connected to the modules for storing the at least one standard and the at least one procedure such that standard and procedure are linked to one another.

2. The system of claim 1 wherein the module for scoring the proposed standard develops a rationalization score that is used to accept or reject the proposed standard.

3. The system of claim 1 wherein the module for scoring the proposed standard develops a risk score that is used to accept or reject the proposed standard.

4. The system of claim 1 wherein the module for scoring the proposed standard develops an operational impact score that is used to accept or reject the proposed standard.

5. The system of claim 1 wherein the module for scoring the proposed procedure develops an operational impact score that is used to accept or reject the proposed procedure.

6. The system of claim 1 wherein the module for scoring the proposed procedure uses a score related to the proposed standard to accept or reject the proposed procedure.

7. The system of claim 6 wherein the module for scoring the proposed procedure uses a risk score for the proposed standard that is used to accept or reject the proposed procedure.

8. The system of claim 6 wherein the module for scoring the proposed procedure uses a rationalization score for the proposed standard that is used to accept or reject the proposed procedure.

9. A method of rationalizing proposed standards and procedures, the method comprising:
defining a proposed standard;
scoring the proposed standard;
defining a proposed procedure;
mapping the proposed procedure to the proposed standard;
scoring the proposed procedure; and
linking the proposed standard to a rule and linking the proposed procedure to the proposed standard.

10. The method of claim 9 further including analyzing the proposed standard to determine if the proposed standard meets a criteria for a standard.

11. The method of claim 9 further including analyzing the proposed procedure to determine if the proposed procedure meets a criteria for a standard.

12. The method of claim 9 wherein the standard is scored based on its relationship to a rule.

13. The method of claim 12 wherein the standard is scored based on the importance of the rule.

14. The method of claim 9 wherein the standard is scored based on a risk associated with not complying with the standard.

15. The method of claim 9 wherein the standard is scored based on the operational impact associated with complying with the standard.

16. The method of claim 9 wherein the standard is scored by summing scores based on the importance of a rule to which the standard relates; a risk associated with not complying with the standard; and an operational impact associated with complying with the standard.

17. The method of claim 9 wherein the standard is scored based on the importance of a plurality of rules to which the standard relates where the plurality of rules are weighted relative to one another.

18. The method of claim 9 wherein the standard is scored based on a plurality of risks associated with not complying with the standard where the plurality of risks are weighted relative to one another.

19. The method of claim 9 wherein the standard is scored based on a plurality of operational impacts associated with complying with the standard where the plurality of operational impacts are weighted relative to one another.

20. The method of claim 9 wherein the procedure is scored based on the importance of a rule to which the standard relates.

21. The method of claim 9 wherein the procedure is scored based on a risk associated with not complying with the standard.

22. The method of claim 9 wherein the procedure is scored based on an operational impact associated with complying with the procedure.

23. The method of claim 9 wherein scoring a proposed standard results in a score that determines if the proposed standard is accepted, and accepting the proposed standard regardless of the score based on a critical factor.

24. The method of claim 9 wherein scoring a proposed standard results in a score that determines if the proposed standard is accepted, and rejecting the proposed standard regardless of the score based on a critical factor.

25. An apparatus for rationalizing proposed standards and procedures comprising:
means for scoring a proposed standard;
means for mapping a proposed procedure to the proposed standard;
means for scoring the proposed procedure; and
means for linking the proposed standard to a rule and linking the proposed procedure to the proposed standard.
